(19) United States
(12) Patent Application Publication
(10) Pub. No.: US 2013/0205260 A1
(43) Pub. Date: Aug. 8, 2013

(54) METHOD AND APPARATUS FOR MANAGING AN APPLICATION IN A MOBILE ELECTRONIC DEVICE

(71) Applicant: Samsung Electronics Co., Ltd, Gyeonggi-do (KR)

(72) Inventor: Yeul-Tak Sung, Seoul (KR)

(73) Assignee: SAMSUNG ELECTRONICS CO., LTD, Gyeonggi-do (KR)

(21) Appl. No.: 13/757,572

(22) Filed: Feb. 1, 2013

(30) Foreign Application Priority Data
Feb. 2, 2012 (KR) 10-2012-0010727

(51) Int. Cl. G06F 3/0481

(52) U.S. Cl. CPC G06F 3/04817
USPC 715/835

(57) ABSTRACT

According to certain embodiments, an apparatus and a method for managing an application in a mobile electronic device includes tags corresponding to a plurality of applications, respectively, operating in the mobile electronic device are displayed. One of the tags is selected under a user control, and at least one application corresponding to the selected tag is displayed. Once an application is selected under the user control, the selected application is then executed.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Feb. 2, 2012 and assigned Ser. No. 10-2012-0010727, the entire disclosure of which is hereby incorporated by reference.

### TECHNICAL FIELD OF THE INVENTION

The present invention relates to a mobile electronic device, and more particularly, to a method and an apparatus for managing an application in a mobile electronic device.

### BACKGROUND OF THE INVENTION

As use of mobile electronic devices increases, mobile electronics companies are continually developing electronic devices for providing various and convenient additional functions. Particularly, various applications for providing various functions for the user's convenience and leisure time are provided. Therefore, the mobile electronic device can often have numerous applications.

In the case where a particular mobile electronic device has multiple applications, it is often difficult for a user to find out a desired application. Therefore, the conventional mobile electronic device provides a function for facilitating a user's accessibility to each application by managing a plurality of applications for each folder. For example, a user of the mobile electronic device may generate a game folder and a life folder to which icons representing a plurality of game applications and icons representing a scheduler, a morning call, and traffic information related applications to the life folder, thereby accessing a relevant application via the folders can be added.

However, according to the above-described method, although the multiple applications can be classified into one or more folders, numerous applications may be included in each folder, such that the user may have difficulty in finding a desired application in the folder. For example, in the case where the user has classified a large number of game applications using the game folder, it can be difficult for the user to find a desired game.

### SUMMARY OF THE INVENTION

To address the above-discussed deficiencies of the prior art, it is a primary object to provide to provide a method and an apparatus for managing an application in a mobile electronic device.

Another aspect of the present invention is to provide a method and an apparatus for managing a tag-based application in a mobile electronic device.

Still another aspect of the present invention is to provide a method and an apparatus for registering a tag associated with each application and then accessing a desired application using the tag in a mobile electronic device.

Yet another aspect of the present invention is to provide a method and an apparatus for configuring a menu using a tag registered for each application in a mobile electronic device.

Still yet another aspect of the present invention is to provide a method and an apparatus for editing a tag registered for each application in a mobile electronic device.

Still yet further another aspect of the present invention is to provide a method and an apparatus for collecting tag information from different users having the same application and registering a tag for the same application in a mobile electronic device.

In accordance with an aspect of the present invention, a method for managing an application in a mobile electronic device includes displaying multiple tags corresponding to a corresponding multiple applications operating in the mobile electronic device, selecting one of the tags under a user control, displaying at least one application corresponding to the selected tag, selecting one application under the user control, and executing the selected application.

In accordance with another aspect of the present invention, a method for managing an application in a server includes receiving tag information from at least one mobile electronic device having a specific application, mapping the received tag information to the specific application, receiving a request from the mobile electronic device to transmit the tag information for the specific application, and transmitting the tag information mapped to the specific application to the mobile electronic device.

In accordance with still another aspect of the present invention, an apparatus for managing an application in a mobile electronic device includes an input unit configured to detect a user input, an output unit configured to display data, and a controller configured to display multiple tags corresponding to multiple applications operating in the mobile electronic device, selecting one of the tags via a user input, displaying at least one application corresponding to the selected tag, selecting one application via a user input, and executing the selected application.

In accordance with still further another aspect of the present invention, an apparatus for managing an application in a server includes a communication unit configured to transmit/receive a signal to/from a mobile electronic device, and a controller for receiving tag information from at least one mobile electronic device having a specific application, mapping the received tag information to the specific application, receiving a request from the mobile electronic device to transmit the tag information for the specific application, and transmitting the tag information mapped to the specific application to the mobile electronic device.

Other aspects, advantages and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example mobile electronic device according to certain embodiments of the present invention;

FIG. 2 illustrates an example server according to certain embodiments of the present invention;

FIGS. 3A to 3C illustrates example procedure for operating a mobile electronic device according to certain embodiments of the present invention;

FIG. 4 illustrates an example procedure for operating a server according to certain embodiments of the present invention;

FIGS. 5A and 5B illustrate an example method for switching to a tag list in a mobile electronic device according to certain embodiments of the present invention;

FIGS. 6A and 6C illustrates an example method for accessing a desired application using a tag in a mobile electronic device according to certain embodiments of the present invention;

FIGS. 7A and 7B illustrates an example method for switching from a tag list to an application list in a mobile electronic device according to certain embodiments of the present invention;

FIGS. 8A and 8C illustrates an example method for switching to a tag edit mode in a mobile electronic device according to certain embodiments of the present invention; and

FIGS. 9A and 9C illustrates an example method for editing a tag registered in an application in a mobile electronic device according to certain embodiments of the present invention.

Throughout the drawings, like reference numerals will be understood to refer to like parts, components and structures.

### DETAILED DESCRIPTION OF THE INVENTION

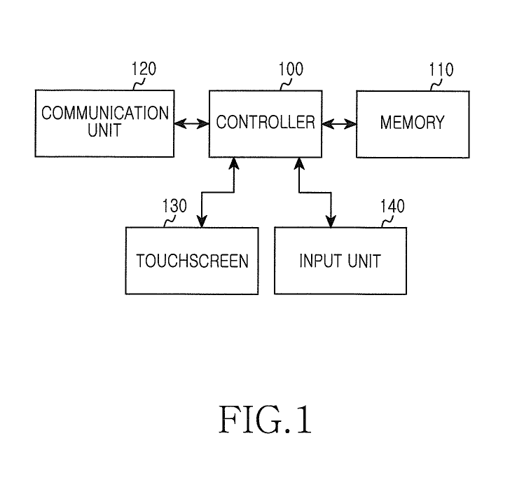

FIGS. 1 through 9C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile electronic devices. The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

Exemplary embodiments of the present invention provide a method and an apparatus for registering a tag regarding each application and accessing a desired application using the registered tag in a mobile electronic device. Here, the mobile electronic device includes all electronic devices providing an application such as a portable electronic device, a mobile phone, a mobile pad, a media player, a tablet personal computer, a hand-held computer, and a Personal Digital Assistant (PDA). The application denotes software executed on an operating system of the mobile electronic device, and is referred to as an application for convenience in description. In addition, the tag denotes a symbol representing a characteristic of various applications. For example, the tag may be expressed in terms of numbers, characters, codes, etc. representing a characteristic of a relevant application.

FIG. 1 is a block diagram illustrating a mobile electronic device according to certain embodiments of the present invention.

Referring to FIG. 1, the mobile electronic device includes a controller 100, a memory 110, a communication unit 120, a touchscreen 130, and an input unit 140. Elements of the mobile electronic device communicate with each other via one or more communication buses or signal lines. In addition, the elements may be implemented using one or more hardware devices, such as an integrated circuit, or software, or a combination of hardware and software. The configuration of the mobile electronic device is shown as an example, and the mobile electronic device may further include additional elements besides those illustrated, and may be configured in a manner different from the illustrated configuration.

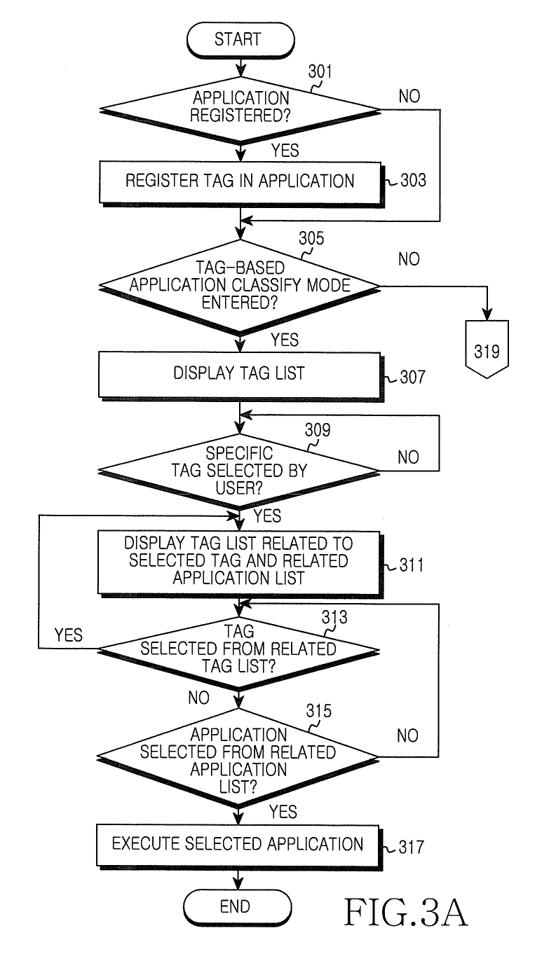

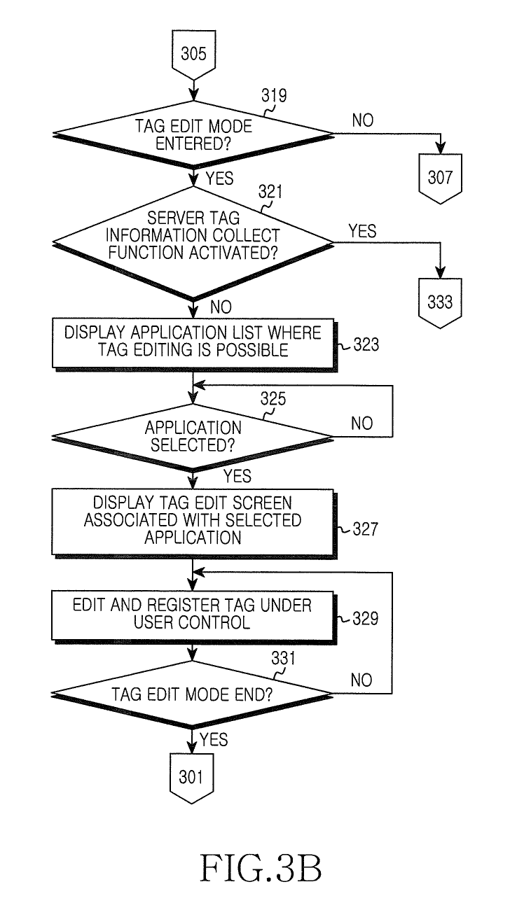

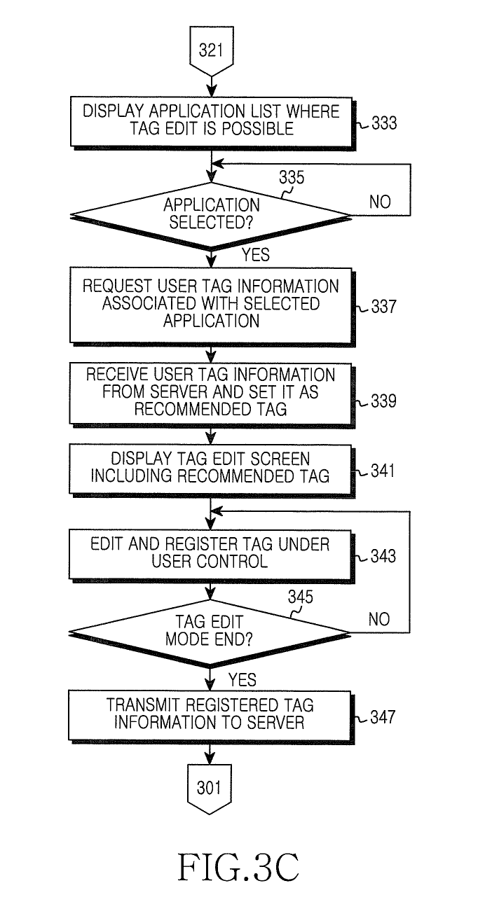

The controller 100 controls and processes an overall operation of the mobile electronic device, controls and processes functions for registering a tag for an application, and editing the registered tag. In addition, the controller 100 controls and processes functions for configuring a tag menu using tags registered in the stored application, and displays the configured menu on a screen. In addition, the controller 100 controls and processes functions for displaying an application list corresponding to a tag selected by a user from the tag menu, and executing an application selected by the user from the application list. The controller 100 controls and processes functions for obtaining classified information for a received application when receiving an application from a server, and registering a tag for a relevant application using the obtained classified information. In addition, the controller 100 controls and processes functions for transmitting tag information registered for each application to the server, and receiving tag information registered by other users possessing the same application from the server. At this point, the controller 100 controls and processes functions for setting the tag information registered by other users possessing the same application as a recommended tag for the relevant application, and then providing the recommended tag to a user when editing a tag of the application. That is, the controller 100 performs controls and processes for performing operations described in FIGS. 3A to 3C.

The memory 110 stores various programs for operating the mobile electronic device and data. The memory 110 stores various applications and stores tag information for each application under control of the controller 100. In addition, the memory 110 stores tag information that can be registered with the various applications. At this point, the tag information that can be registered may be a tag stored in advance during manufacture of the mobile electronic, may be a tag received from the server, and may be a tag collected from a log generated during an operation of the mobile electronic device. In addition, the memory 110 stores recommended tag information for each application under control of the controller 100. Here, the recommended tag information may include classified information of the relevant application and tag information registered by other users with respect to the relevant application. In addition, the memory 110 stores use frequency, a recent register time, and the number of related applications for each tag. Here, the use frequency denotes a user selection frequency for a relevant tag, the recent register time denotes a time at which how recently a relevant tag has been registered in an application, and the number of related applications denotes the number of applications in which a relevant tag has been registered.

The communication unit 120 transmits/receives data to/from an external device under control of the controller 100. Particularly, according to the present invention, the communication unit 120 transmits tag information registered in a specific application to the server and receives tag information from the server to provide the same to the controller 100.

The touchscreen 130 includes a touch detect surface for detecting a user contact to detect the user contact and provides the detection result to the controller 100. The touchscreen 130 detects an operation related to the user contact, for example, whether the user contact has been made, a coordinate of a contact point, movement of a contact point, and a contact ending. At this point, the touchscreen 130 detects movement of a contact point using at least one of a speed, a velocity, and an acceleration at which a contact point changes. In addition, the touchscreen 130 detects multiple contact points to determine whether a multi-touch action has been made.

In addition, the touchscreen 130 displays various state information, such as numbers, characters, and images generated during an operation of the mobile electronic device under control of the controller 100. Here, the touchscreen 120 may perform a display function using a Liquid Crystal Display (LCD) technology, a Light Emitting Diode (LED) technology, a Light Emitting Polymer Display (LPD) or Organic Light Emitting Diode (OLED) technology, for example. According to certain embodiments, the touchscreen 130 displays icons representing various applications and displays a tag menu including a tag list. At this point, various tags included in the tag menu apply color, a size, a thickness, a font, a highlight mark, etc. depending on at least one of a use frequency, recent registration, and the number of related applications, and display the same.

The input unit 140 receives a user input and provides data corresponding to the user input to the controller 100. The input unit 140 may be an input unit such as a touch pad, a keypad, a keyboard, a button, a dial, a stick, a switch, a microphone, etc.

The method described above in relation with FIG. 1 under of the present invention may be provided as one or more instructions in one or more software modules stored in the respective electronic devices.

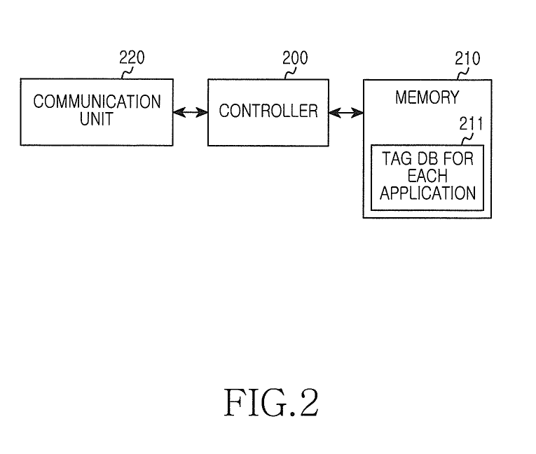

FIG. 2 illustrates an example server according to certain embodiments of the present invention.

Referring to FIG. 2, the server includes a controller 200, a memory 210, and a communication unit 220. Elements of the server communicate with each other via one or more communication buses or signal lines. In addition, the elements may be implemented using one or more hardware such as an integrated circuit, or software, or a combination of hardware and software. The configuration of the server shown in only an example; the server may further include an additional element besides the illustrated elements, and may be configured in a way different from the illustrated configuration.

The controller 200 controls and processes an overall operation of the server, and performs a function for managing tag information of various applications registered in the server to provide the same to a terminal. In detail, the controller 200 stores classified information for each application registered in the server, and when requested by a specific mobile electronic device to transmit a specific application, controls a function for transmitting classified information as tag information of the specific application. In addition, the controller 200 receives the tag information of the specific application from the mobile electronic device to store the information as the tag information of the relevant application, and then controls and processes a function for transmitting the stored tag information of the specific application to a different electronic device according to a request of the different electronic device possessing the specific application. At this point, when the number of tags for the specific application exceed a threshold as a result of reception of the tag information of the specific application from a plurality of mobile electronic devices having the specific application, the controller 200 determines and stores a priority of each tag, and when requested by an arbitrary mobile electronic device to transmit tag information of the specific application, controls a function for selecting a predetermined number of tags in a high priority order to transmit the same. At this point, the priority of each tag may be determined depending on the number of mobile electronic devices that have a relevant tag associated with a relevant application.

The memory 210 stores various programs for an overall operation of the server, and data. Particularly, the memory 210 stores various applications, and stores tag DB 211 for each application representing tag information associated with each application. Here, the tag information associated with each application may include classified information representing classification of a relevant application in the server and a tag received from a mobile electronic device having a relevant application.

The communication unit 220 transmits/receives data to/from an external device under control of the controller 200. Particularly, the communication unit 220 transmits tag information of a specific application to a mobile electronic device and receives tag information of a specific application from the mobile electronic device to provide the same to the controller 200.

FIGS. 3A to 3C illustrate an example procedure for operating a mobile electronic device according to certain embodiments of the present invention.

Referring to FIGS. 3A to 3C, the mobile terminal determines whether an application is registered in step 301. That is, the mobile electronic device determines whether a specific application is downloaded from a server and installed. When the application is not registered, the mobile electronic device immediately proceeds to step 305.

In contrast, when the application is registered, the mobile electronic device obtains and registers tag information of the application in step 303. Here, the mobile electronic device may obtain the tag information from classified information of the application or obtain the tag information from meta data of the application. At this point, the mobile electronic device may automatically register the obtained tag information as the tag associated with the application without performing a separate user control process, and may request that a user register the tag and register the tag associated with the application under the user control. Here, in case of requesting the user to register the tag, the mobile electronic device may provide the obtained tag information as recommended tags in order to allow the user to easily register the tag.

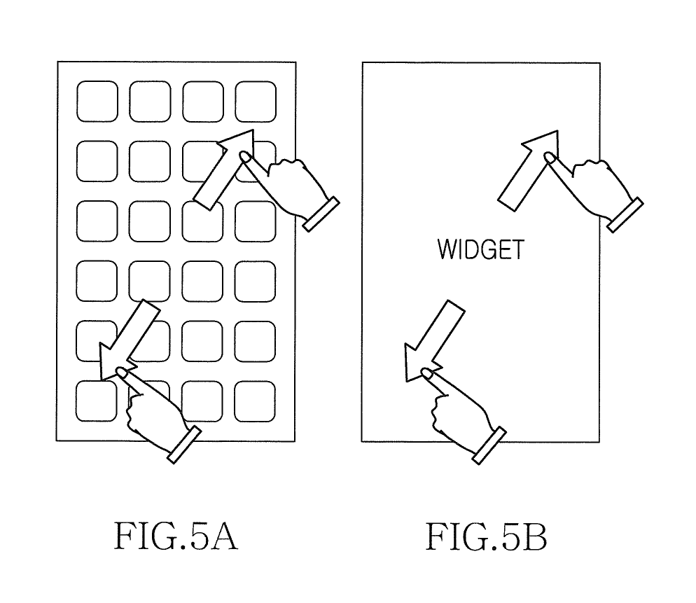

After that, the mobile electronic device determines whether the electronic device enters a tag-based application classify mode in step 305. At this point, the tag-based application classify mode denotes a mode for accessing a desired application using tags registered in the application. The mobile electronic device may enter the tag-based application classify mode via a predetermined touch method or via a predetermined specific key button or menu selection. For example, as illustrated in FIGS. 5A and 5B, when a user's multi-touch occurs on a screen on which a plurality of applications are displayed, or the user's multi-touch occurs on a widget screen, the mobile electronic device may enter the tag-based application classify mode. Of course, such a mode entering method is only an example and it is obvious that the mobile electronic device may enter the tag-based application classify mode via various methods depending on a design scheme.

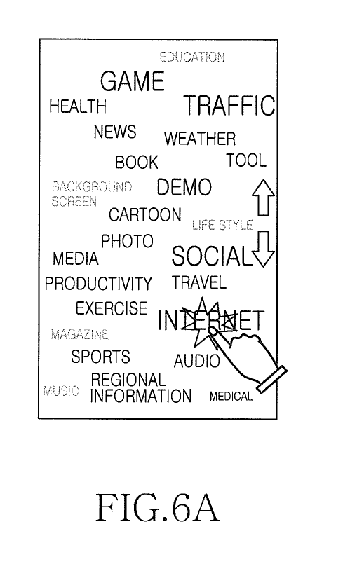

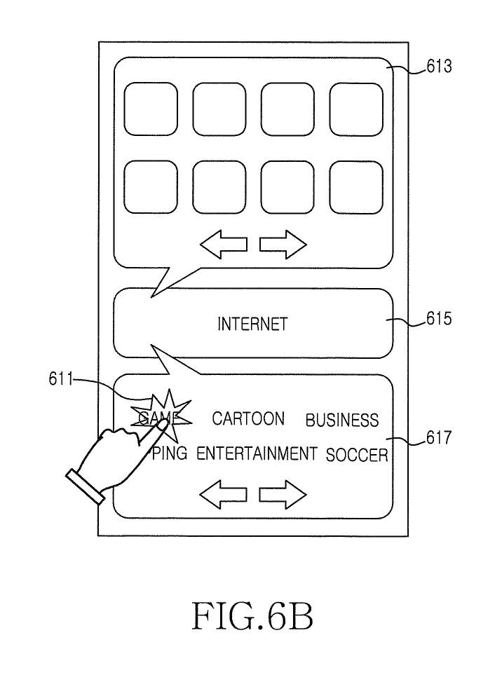

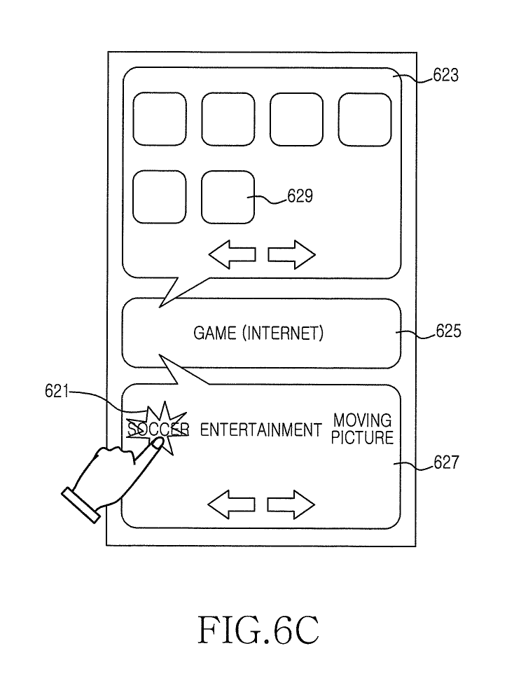

When entering the tag-based application classify mode, the mobile electronic device displays a tag list representing tags regarding various applications stored in the mobile electronic device in step 307. The mobile electronic device applies color, a size, a thickness, a font, a highlight mark, etc. of each tag included in the tag list depending on a use frequency, recent registration, and the number of related applications of each tag, and displays the same. For example, as illustrated in FIG. 6A, the mobile electronic device displays a tag list representing tags registered with each application. At this point, the mobile electronic device may display games, traffic, a demonstration, a social tag, and Internet tags where use frequency is high and the number of applications is large in a large size and having a thick thickness. The mobile electronic device may display a background screen, a life style, magazines, and music tags where use frequency is low and the number of related applications is small in a small size and a dim font. In addition, the mobile electronic device may determine a display position of each tag depending on use frequency, a recent registration time, and the number of related applications of each tag. In addition, in the case where the number of total tags included in the tag list exceeds a maximum number of tags displayable on the screen, the mobile electronic device displays tags corresponding to the maximum number of tags among the total tags on the screen and then display other tags on the screen via a user's screen manipulation. Here, the tag list may be updated every time when the application is registered, the tag is registered, the tag is edited, and the tag is selected.

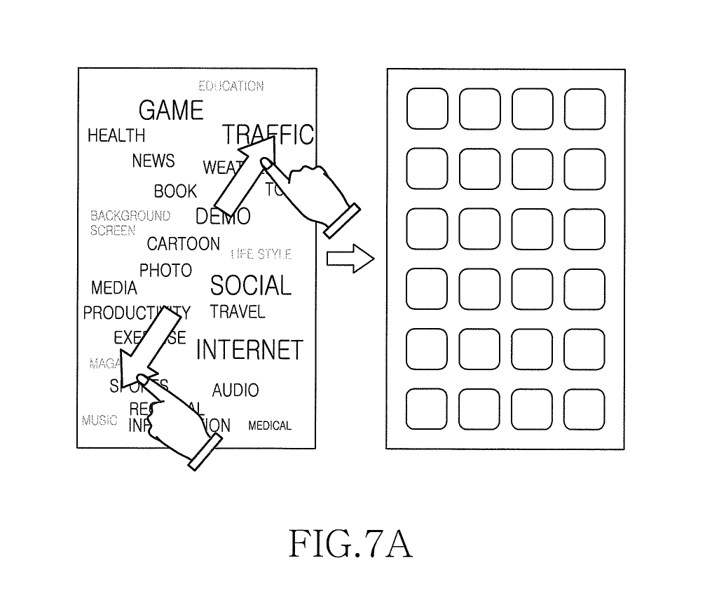

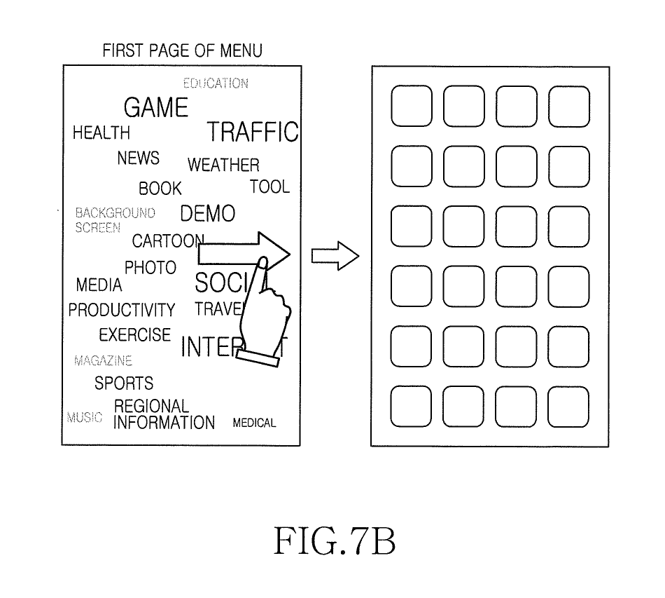

After that, the mobile electronic device proceeds to step 309 to determine whether a specific tag is selected from the tag list under a user control. Here, though not shown, when a specific tag is not selected and a predetermined touch method is detected while the tag list is displayed, the mobile electronic device may switch from the tag-based application classify mode to a basic mode to display an application list. For example, as illustrated in FIGS. 7A and 7B, when a multi-touch movement or a touch movement to a specific direction is detected while the tag list is displayed, the mobile electronic device may perform screen switching that displays an application list instead of the tag list.

When the specific tag is selected from the tag list, the mobile electronic device displays a tag list related to the selected tag and a related application list. Here, the related application list denotes an application in which the selected tag has been registered, and the related tag list denotes tags registered in applications included in the related application list. In other words, the related tag list denotes other tags registered in an application corresponding to the selected tag. For example, as illustrated in FIG. 6A, in the case where a user selects an “Internet” tag 615, the mobile electronic device may display an application list 613 related to the “Internet” tag 615 on the upper portion of the screen and display a tag list 617 related to the “Internet” tag 615 on the lower portion of the screen as illustrated in FIG. 6B. Here, the display position of the related application list 613 and the related tag list 615 is only an example and may change depending on a design scheme. Here, in the case where the number of all applications included in the related application list exceeds a maximum threshold, the mobile electronic device may display a predetermined number of applications on the screen among the total applications, and then display other applications on the screen via a user's screen manipulation. Likewise, in the case where the number of total tags included in the related tag list exceeds a maximum threshold, the mobile electronic device may display a predetermined number of tags on the screen among the total tags, and then display other tags on the screen via the user's screen manipulation.

After that, the mobile electronic device determines whether a specific tag has been selected from the related tag list under a user control in step 313. When the specific tag has been selected from the related tag list under the user control, the mobile electronic device returns to step 311 to display a tag list related to the selected tag and a related application list. For example, as illustrated in FIG. 6B, in the case where the user selects a “game” tag 625 from the related tag list 617, the mobile electronic device may display an application list 623 related to the “game” tag 625 on the upper portion of the screen and display a tag list 627 related to the “game” tag 625 on the lower portion of the screen as illustrated in FIG. 6C. At this point, the mobile electronic device may represent that the related application list 623 and the related tag list 627 currently being displayed are related to the “game” tag and the “Internet” tag by displaying the “Internet” tag has been selected on the screen prior to the “game” tag.

In contrast, when the specific tag is not selected from the related tag list under the user control, the mobile electronic device proceeds to step 315 to determine whether an application has been selected from the related application list. When the specific application is selected from the related application list, the mobile electronic device executes the selected application and ends the algorithm according to the present invention. For example, as illustrated in FIG. 6C, when the user selects a specific application 629 from a related application list 623, the mobile electronic device executes the selected specific application 629. In contrast, when the specific application is not selected from the related application list, the mobile electronic device returns to step 313 to re-perform subsequent steps.

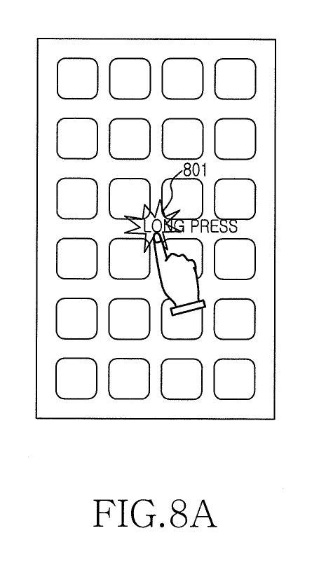

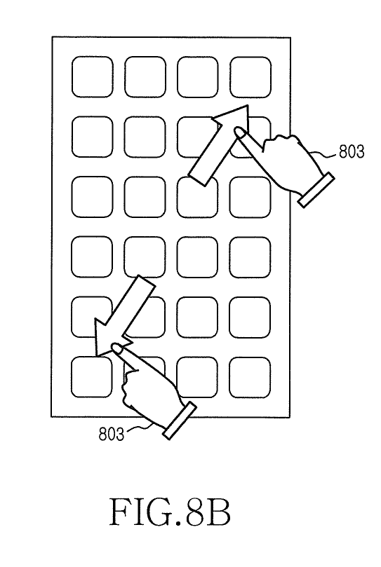

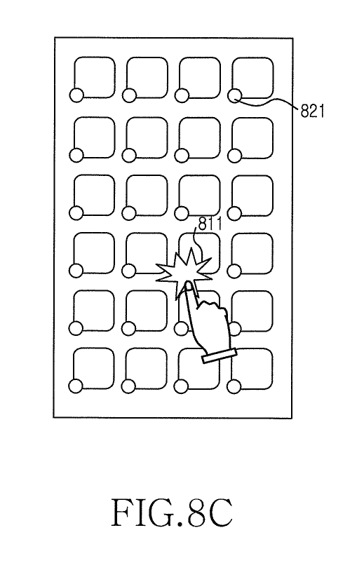

In contrast, when the mobile electronic device does not enter the tag-based application classify mode, the mobile electronic device determines whether it has entered a tag edit mode in step 319. Here, the tag edit mode denotes a mode for editing tags registered with an application. The mobile electronic device may enter the tag edit mode via a predetermined touch method or a predetermined specific key button or menu selection. For example, when a region on which an icon representing an application is not displayed, that is, a background region is touched for a predetermined time as illustrated in FIG. 8A, or when a user's multi-touch movement occurs on the screen that displays an application list as illustrated in FIG. 8B, the mobile electronic device may enter the tag edit mode. Of course, such a mode entering method is only an example and it is obvious that the mobile electronic device may enter the tag edit mode via various methods depending on a design scheme. Here, when the mobile electronic device does not enter the tag edit mode, the mobile electronic device returns to step 307 to re-perform subsequent steps.

When the mobile electronic device enters the tag edit mode, the mobile electronic device determines whether a server tag information collect function has been activated in the mobile electronic device in step 321. Here, the server tag information collect function denotes a function for collecting tag information registered for the same application by a different user who has downloaded the same application from a server. Here, the active state of the server tag information collect function may be fixed at an active state or an inactive state depending on a design scheme, and may be changed by a user. When the server tag information collect function is activated, the mobile electronic device proceeds to step 333.

In contrast, when the server tag information collect function is not activated, the mobile electronic device displays an application list where tag editing is possible among various applications stored in the mobile electronic device in step 323. For example, as illustrated in FIG. 8C, the mobile electronic device may display an application list, and at this point, add an edit mark 821 representing a tag edit function to an icon of each application and display the same. At this point, tags of all applications stored in the mobile electronic device may be editable depending on a design scheme, and only applications besides a designated application among all the applications may be editable.

After that, the mobile electronic device proceeds to step 325 to determine whether a specific application is selected from the application list where tag editing is possible. For example, as illustrated in FIG. 8C, the mobile electronic device determines whether a user selects (811) an edit display region of a specific application in an application list where the edit mark 821 representing a tag edit is possible has been added to an icon of each application.

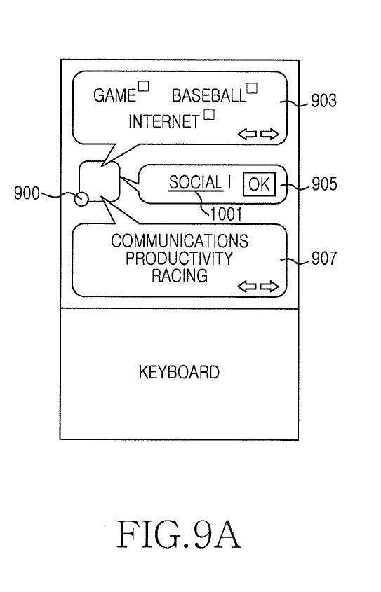

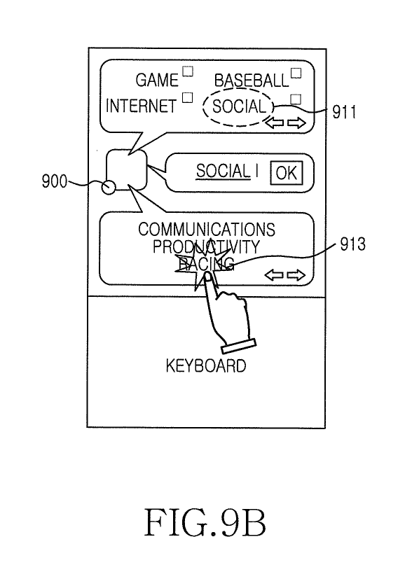

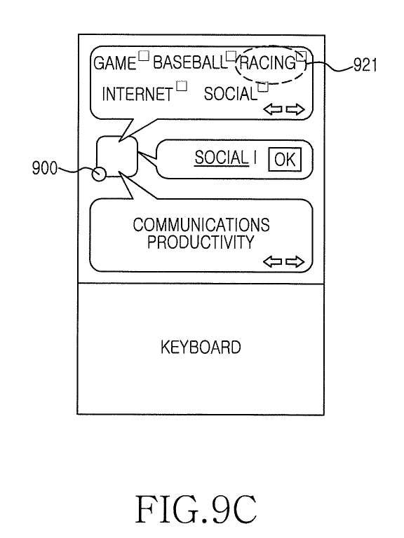

When a specific application is selected from the application list where the tag editing is possible, the mobile electronic device proceeds to step 327 to display a tag edit screen for the selected application. At this point, the tag edit screen may include a registration tag list representing tags registered in advance with respect to a relevant application, a recommended tag list representing recommended tags that can be registered for the relevant application, a user input window for receiving a tag from a user, and a keyboard (or a keypad, a character input window). For example, as illustrated in FIG. 9A, in the case where a user selects a specific application, the mobile electronic device may display a registration tag list 903 representing “game”, “baseball” and “Internet” tags registered in advance in the specific application, display a recommended tag list 907 representing “Communication”, “Productivity”, and “Racing” tags that can be registered for the specific application, and display a window 905 that allows the user to input a desired “Social” tag via the keyboard. Here, tags included in the recommended tag list may include a tag stored in advance during manufacture of the mobile electronic device, a tag obtained from classified information of a server for the application, a tag obtained from meta data of the application, and a tag collected from a log generated during an operation of the mobile electronic device.

After that, the mobile electronic device edits a tag to register the tag in the selected application under a user control in step 329. For example, as illustrated in FIG. 9A, the mobile electronic device receives a “Social” tag via a user input window 905, registers the input “Social” tag as a tag of the selected application, and adds the “Social” tag 911 to a registration tag list to display the same as illustrated in FIG. 9B. In addition, as illustrated in FIG. 9B, the mobile electronic device detects that a user has selected a “Racing” tag from the recommended tag list 913 to register the “Racing” tag as the tag of the application, and adds the “Racing” tag 921 to the registration tag list to display the same as illustrated in FIG. 9C.

After that, the mobile electronic device proceeds to step 331 to determine whether a tag edit mode ends. The tag edit mode may end via a predetermined touch method, a predetermined specific key button, or menu selection. For example, as illustrated in FIGS. 9A to 9C, when an edit mark region 900 additionally displayed in an icon representing an application is touched, the mobile electronic device may end the tag edit mode. Of course, this mode ending method is exemplarily described and it is obvious that the mode ending method may change depending on a design scheme.

When the tag edit mode does not end, the mobile electronic device returns to step 327. In contrast, when the tag edit mode ends, the mobile electronic device returns to step 301 to re-perform subsequent steps.

Meanwhile, when the server tag information collect function is activated, the mobile electronic device proceeds to step 333 to display an application list where tag editing is possible among various applications stored in the mobile electronic device. For example, as illustrated in FIG. 8C, the mobile electronic device may display an application list, and at this point, add an edit mark 821 representing that tag editing is possible to an icon of each application to display the same.

After that, the mobile electronic device proceeds to step 335 to determine whether a specific application is selected from an application list where the tag editing is possible. For example, as illustrated in FIG. 8C, the mobile electronic device determines whether a user selects (811) an edit mark region of a specific application from an application list where the edit mark 821 representing that the tag editing is possible has been added to an icon of each application.

When a specific application is selected from the application list where the tag editing is possible, the mobile electronic device requests a server corresponding to the selected application to transmit user tag information for the selected application in step 337, and receives the user tag information from the server to set the relevant tag as a recommended tag for the selected application in step 339. Here, the user tag information received from the server denotes tag information which a user of a different mobile electronic device possessing the selected application has registered for the selected application.

After that, the mobile electronic device displays a tag edit screen including the recommended tag with respect to the selected application in step 341. At this point, the tag edit screen may include a registration tag list representing tags registered in advance with respect to a relevant application, a recommended tag list representing recommended tags that can be registered for the relevant application, a user input window for receiving a tag from a user, and a keyboard (or a keypad, a character input window). For example, as illustrated in FIG. 9A, in the case where a user selects a specific application, the mobile electronic device may display a registration tag list 903 representing “game”, “baseball” and “Internet” tags registered in advance in the specific application, display a recommended tag list 907 representing “Communication”, “Productivity”, and “Racing” tags that can be registered for the specific application, and display a window 905 that allows the user to input a desired “Social” tag via the keyboard. Here, tags included in the recommended tag list may include a tag stored in advance while the mobile electronic device is designed, a tag obtained from classified information of a server for the application, a tag obtained from meta data of the application, a tag collected from a log generated during an operation of the mobile electronic device, and user tag information received from the server.

After that, the mobile electronic device edits a tag and registers the tag in the selected application under a user control in step 343. For example, as illustrated in FIG. 9A, the mobile electronic device receives a “Social” tag via the user input window 905, registers the input “Social” tag as a tag of the selected application, and adds the “Social” tag 911 to a registration tag list to display the same as illustrated in FIG. 9B. In addition, as illustrated in FIG. 9B, the mobile electronic device detects that a user has selected a “Racing” tag from the recommended tag list 913 to register the “Racing” tag as the tag of the application, and adds the “Racing” tag 921 to the registration tag list to display the same as illustrated in FIG. 9C.

After that, the mobile electronic device proceeds to step 345 to determine whether a tag edit mode ends. The tag edit mode may end via a predetermined touch method, a predetermined specific key button, or menu selection. For example, as illustrated in FIGS. 9A to 9C, when an edit mark region 900 additionally displayed in an icon representing an application is touched, the mobile electronic device may end the tag edit mode. Of course, this mode ending method shown is only an example and the mode ending method may be different depending on a desired design scheme.

When the tag edit mode does not end, the mobile electronic device returns to step 343. In contrast, when the tag edit mode ends, the mobile electronic device proceeds to step 347 to transmit information regarding a tag registered for the selected application to the server, and returns to step 301 to re-perform subsequent steps.

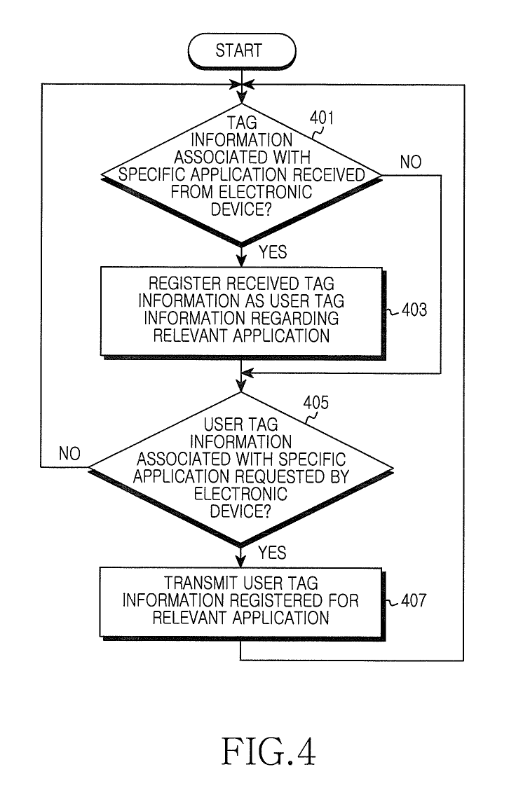

FIG. 4 illustrates an example procedure for operating a server according to certain embodiments of the present invention.

Referring to FIG. 4, the server determines whether tag information associated with a specific application is received from a mobile electronic device in step 401. When the tag information for the specific application is not received from the mobile electronic device, the server proceeds to step 405. In contrast, when the tag information associated with the specific application is received from the mobile electronic device, the server proceeds to step 403 to register the received tag information as tag information associated with the specific application in a DB for each application.

After that, the server determines whether user tag information associated with a specific application is requested by the mobile electronic device in step 403. When the user tag information for the specific application is not requested by the mobile electronic device, the server returns to step 401 to re-perform subsequent steps. In contrast, when the user tag information associated with the specific application is requested by the mobile electronic device, the server proceeds to step 407 to determine tag information registered for the specific application from the DB for each application to transmit the tag information to the mobile electronic device. At this point, when the number of tags for the specific application registered in the DB for each application exceeds a threshold, the server may register a priority of each tag to transmit a predetermined number of tags having a high priority to the mobile electronic device. Here, the server may calculate the number of mobile electronic devices that have registered a relevant tag in the specific application with respect to each tag to determine the priority.

After that, the server returns to step 401 to re-perform subsequent steps.

Though the present invention has described a method for registering a tag in an application and then accessing a desired application, the present invention is applicable to various functions of the mobile electronic system as well as the application. For example, by registering a tag even for information of the mobile electronic device, the present invention may allow a user to select the registered tag to immediately access information of the mobile electronic device without performing a process for accessing a separate setting menu.

The present invention registers a tag for each application and then configures a menu using the registered tag in a mobile electronic device, so that a user may easily access a desired application using the tag. Particularly, the present invention has an effect of easily accessing a desired application by sequentially selecting tags corresponding to the application desired by a user.

Methods according to embodiments described in claims and/or specification of the present invention may be implemented in hardware, software, or a combination of the hardware and the software.

In the case of implementing the method using software, a computer-readable storage medium storing one or more programs (software module) may be provided. One or more programs stored in the computer-readable storage medium are configured for execution by one or more processors inside an electronic device. One or more programs include instructions for allowing the electronic device to execute methods according to the embodiments described in claims and/or specification of the present invention.

This program (a software module, software) may be stored in a non-volatile memory including Random Access Memory (RAM) and a flash memory, Read Only Memory (ROM), Electrically Erasable Programmable Read Only Memory (EEPROM), a magnetic disc storage device, a Compact Disc (CD)-ROM, Digital Versatile Discs (DVDs) or an optical storage device of a different type, and a magnetic cassette. Alternatively, the program may be stored in a memory formed of a combination of a portion or all of these devices. Alternatively, a plurality of respective memories may be provided.

In addition, the program may be stored in an attachable storage device that can access the electronic device via a communication network such as the Internet, an Intranet, a Local Area Network (LAN), a Wide LAN (WLAN), and a Storage Area Network (SAN), or a communication network configured in combination of them. This storage device may access the electronic device via an external port.

In addition, a separate storage device on a communication network may access a mobile electronic device.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for managing an application in a mobile electronic device, the method comprising:
displaying a plurality of tags corresponding to a plurality of applications operating in the mobile electronic device;
selecting one of the tags under a user control;
displaying at least one application corresponding to the selected tag;
selecting the one application under the user control; and
executing the selected application.

2. The method of claim 1, wherein each application configured to operate in the mobile electronic device is mapped to at least one tag.

3. The method of claim 2, further comprising:
after selecting the one tag, displaying other tags mapped to the one application corresponding to the selected tag; and
selecting one tag among the other tags under the user control,
wherein the displaying of the other tags mapped to the at least one other application corresponding to the selected tag is repeated until one other application corresponding to the selected tag is selected.

4. The method of claim 2, wherein the tag mapped to the other application comprises at least one of a tag obtained from classified information associated with a relevant application, a user input tag, a tag registered by a different user possessing the relevant application, and a tag obtained from meta data of the application.

5. The method of claim 1, wherein the displaying of the tags corresponding to the plurality of applications comprises:
applying at least one of color, a size, a thickness, a font, and a highlight mark to each tag based on at least one of use frequency, a recent registration time, and the number of corresponding applications of the each tag to display the application.

6. The method of claim 2, further comprising:
editing the tag mapped to the one application,
wherein the editing of the tag comprises:
displaying the tag mapped to the one application;
receiving a tag regarding the one application from a user; and
additionally mapping the received tag to the one application.

7. The method of claim 6, wherein the editing of the tag comprises:
displaying at least one recommended tag associated with the one application;
selecting a recommended tag under a user control; and
additionally mapping the selected recommended tag to the one application.

8. The method of claim 7, further comprising:
receiving tag information associated with the one application from a server; and
setting a recommended tag using the received tag information,
wherein the tag information received from the server comprises at least one of classified information of the server regarding the one application, and tag information registered by a different user possessing the one application.

9. A method for managing an application in a server, the method comprising:
receiving tag information from at least one mobile electronic device having a specific application;
mapping the received tag information to the specific application;
receiving a request from the mobile electronic device to transmit the tag information for the specific application; and
transmitting the tag information mapped to the specific application to the mobile electronic device.

10. The method of claim 9, wherein the tag information mapped to the specific application comprises classified information of a server associated with the specific application.

11. An apparatus configured to manage an application in a mobile electronic device, the apparatus comprising:
an input unit configured to detect a user input;
an output unit configured to display data; and
a controller configured to:
display a plurality of tags corresponding to a plurality of applications configured to operate in the mobile electronic device;
selecting one of the tags via a user input, displaying at least one application corresponding to the selected tag, selecting one application via a user input; and
executing the selected application.

12. The apparatus of claim 11, wherein each application configured to operate in the mobile electronic device is mapped to at least one tag.

13. The apparatus of claim 12, wherein after selecting the one tag, the controller is configured to display other tags mapped to at least one application corresponding to the selected tag, and select one tag among the other tags via the user input,
wherein the controller repeatedly performs the displaying of the other tags mapped to the at least one application corresponding to the selected tag until one application corresponding to the selected tag is selected.

14. The apparatus of claim 12, wherein the tag mapped to the at least one application comprises at least one of a tag obtained from classified information associated with a relevant application, a user input tag, a tag registered by a different user possessing the relevant application, and a tag obtained from meta data of the application.

15. The apparatus of claim 11, wherein the controller is configured to apply at least one of color, a size, a thickness, a font, and a highlight mark to each tag based on at least one of use frequency, a recent registration time, and a number of corresponding applications of the each tag to display the same.

16. The apparatus of claim 12, wherein the controller is configured to edit the tag mapped to the at least one application,
when editing the tag, the controller is configured to display the tag mapped to the at least one application, receive a tag regarding the at least one application from a user, and map the received tag to the at least one application.

17. The apparatus of claim 16, wherein when editing the tag, the controller is configured to display at least one recommended tag associated with the at least one application, select a recommended tag under a user control, and map the selected recommended tag to the at least one application.

18. The apparatus of claim 17, further comprising:
a communication unit configured to transmit/receive a signal to/from a server, wherein the controller is configured to receive tag information regarding the at least one application from a server, and set a recommended tag using the received tag information, wherein the tag information received from the server comprises at least one of classified information of the server associated with the at least one application, and tag information registered by a different user having the at least one edit-object application.

19. An apparatus for managing an application in a server, the apparatus comprising:
a communication unit configured to transmit/receive a signal to/from a mobile electronic device; and
a controller configured to receive tag information from at least one mobile electronic device having a specific application, map the received tag information to the specific application, receiving a request from the mobile electronic device to transmit the tag information for the specific application, and transmit the tag information mapped to the specific application to the mobile electronic device.

20. The apparatus of claim 19, wherein the tag information mapped to the specific application comprises classified information of a server associated with the specific application.
